(19) United States
(12) Patent Application Publication
(10) Pub. No.: US 2026/0208626 A1
(43) Pub. Date: Jul. 23, 2026

(54) ARRANGEMENT AND METHOD FOR EXTENDING THE RANGE OF AN ELECTRIC VEHICLE

(71) Applicant: AUDI AG, Ingolstadt (DE)

(72) Inventor: Marco PÜSCHNER, Gaimersheim (DE)

(73) Assignee: AUDI AG, Ingolstadt (DE)

(21) Appl. No.: 19/424,914

(22) Filed: Dec. 18, 2025

(30) Foreign Application Priority Data
Jan. 21, 2025 (DE) 102025101928.2

(51) Int. Cl. B60L 58/27; B60K 1/00; B60K 1/04; B60K 11/04

(52) U.S. Cl. CPC B60L 58/27; B60K 1/04; B60K 11/04; B60K 2001/008

(57) ABSTRACT

An arrangement is disclosed for extending the range of an electric vehicle, and includes a coolant circuit, at least one component of the electric vehicle and at least one interior heat exchanger, and at least one burner which is thermally connected to the coolant circuit and is configured to generate heat energy and supply it to the coolant circuit. The at least one component and/or the interior heat exchanger can be thermally connected to the coolant circuit via at least one valve.

### FIELD

The invention relates to an arrangement for extending the range of an electric vehicle, comprising a coolant circuit, at least one electrical component of the electric vehicle and at least one interior heat exchanger. The invention further relates to a method for producing such an arrangement and to a method for extending the range.

### BACKGROUND

In current electrically powered vehicles, energy for heating or thermal conditioning is mainly drawn from the traction battery, in addition to the waste heat from the electrical components. Electrical energy is converted into thermal energy using a heating element and/or a heat pump within a cooling circuit. This allows for the targeted heating of drive components, the traction battery and the vehicle interior before and during driving. However, such measures result in a loss of the vehicle's range at low ambient temperatures and thus in inconsistency due to significant range differences between journeys with the vehicle in summer and in winter.

In DE 10 2011 014 712 A1, an air conditioning system for temperature control of the interior of an electric vehicle is described using a refrigerant circuit of a heat pump. The refrigerant circuit has an additional heat exchanger, which is heated by a connected heating circuit. The heating circuit is heated by a burner fueled by fossil fuels.

DE 10 2011 001 992 A1 discloses a system for air conditioning an electric vehicle with a climate box comprising a heating device. To increase the range of the electric vehicle, the climate control box is equipped with an internal combustion engine.

### SUMMARY

The object of the present invention is to provide an arrangement and a method by which the range of electrically powered vehicles can be extended.

This object is achieved according to the invention by an arrangement, by a vehicle and by a method. Advantageous embodiments and developments of the invention are specified in the claims.

According to one aspect of the invention, an arrangement is provided which is designed to effect an extension of the range of an electric vehicle. The arrangement comprises a coolant circuit, at least one component of the electric vehicle and at least one interior heat exchanger. Furthermore, the arrangement includes at least one burner which is thermally connected to the coolant circuit. The at least one burner is designed to generate heat energy and transfer it to the coolant circuit, wherein the at least one component and/or the interior heat exchanger can be thermally connected to the coolant circuit via at least one valve.

The arrangement according to the invention makes it possible to heat or condition the coolant circuit or cooling water circuit in the vehicle using the burner. The burner can be designed in the form of an energy converter (chemical-thermal) to generate the necessary heat energy by burning a fuel. The at least one burner can be operated with a liquid fuel and/or a gaseous fuel and/or a solid fuel to generate heat energy. The components, such as the drive unit, traction battery and/or the interior heat exchanger for heating the vehicle interior, can be brought to and maintained at their respective operating temperature in a targeted and efficient manner. At least one component can therefore be designed as an electrical component. The extraction of electrochemically stored energy from the traction battery for the implementation of the heating functions is therefore not necessary, which avoids negative effects on the range of the electric vehicle and the arrangement according to the invention results in an extension of the electrically powered range of the electric vehicle.

According to another aspect of the invention, a vehicle is provided which is designed as an electric vehicle. The vehicle has an arrangement according to the invention. Furthermore, the vehicle has at least one traction battery for providing electrical energy. In addition, further components are provided, such as power electronics, electric motors for propelling the vehicle, actuators and further electric motors for implementing support functions, such as steering assistance, and the like. At least one interior heat exchanger is provided for the climate control of the vehicle interior.

The respective electrical components and the interior heat exchanger are thermally coupled to each other via one or more coolant circuits. Corresponding valves arranged in a respective coolant circuit can thermally decouple the interior heat exchanger and/or at least one component from the coolant circuit in order to enable a targeted supply of heat energy depending on a demand for heat energy or heating requirements.

With this arrangement, the heating demand can be at least partially met by the at least one burner. The waste heat generated by the electrical components can also be provided and used as usable thermal energy in the coolant circuit.

According to another aspect of the invention, a method for extending the range of an electric vehicle is provided. The heating requirement of at least one electrical component and/or the vehicle interior is determined in one step of the method. Subsequently, at least one burner of an arrangement according to the invention is activated and/or its output is regulated based on the determined heating requirement.

In a further step of the method, heat energy generated by the burner is fed into a coolant circuit. The heat energy fed into the coolant circuit is then, controlled by at least one valve, supplied to at least one electrical component and/or to the interior heat exchanger. The at least one component and/or the interior heat exchanger can be connected to the coolant circuit via the at least one valve to absorb heat energy provided by the burner. This allows heating requirements to be met without accessing the electrical energy of the traction battery, and extends or increases the electrically powered range of the vehicle.

The at least one burner can be designed as a thermal auxiliary heater and converts the chemical energy of a fuel into thermal energy. The generated heat energy is transferred to the coolant circuit via a heat exchanger. Using suitable switching elements, the individual water circuits or branches in the coolant circuit can be connected or disconnected to heat different electrical components as needed before and during vehicle operation. This allows at least one burner to be used via the coolant circuit to specifically meet the heating requirements of a plurality of different components or regions of the vehicle.

In an exemplary embodiment, the at least one component of the electric vehicle designed as an electrical component is configured to release heat energy in the form of power loss to the coolant circuit during operation and to absorb heat energy provided by the burner for thermal conditioning before operation. Similarly, the vehicle interior can be designed to absorb heat energy before or during operation of the electric vehicle via the interior heat exchanger. The heat energy provided by the at least one electrical component and/or the burner can therefore be used to heat the vehicle interior.

The at least one burner of the arrangement can be used similarly to a parking heater to precondition the vehicle interior when stationary or during the charging process of the electric vehicle. In addition, the burner can be used to heat the vehicle interior and/or the components of the electric vehicle initially or before starting the journey, or to heat them when the electric vehicle is in operation.

The at least one burner can advantageously be designed to utilize different fuels in order to generate heat energy. In addition to conventional fuels such as gasoline, diesel, natural gas, propane, butane and the like, alternative fuels such as hydrogen, wood pellets and the like can also be used to optimize the CO2 balance of the electric vehicle with the burner.

According to another embodiment, the interior heat exchanger can be connected to the coolant circuit via the at least one valve when heating is required in the interior of the electric vehicle. This measure enables a demand-controlled supply of heat energy depending on the heating requirements of electrical components and/or the vehicle interior.

According to a further exemplary embodiment, the at least one burner can be activated or controlled when a heating requirement or a change in the heating requirement of the at least one electrical component and/or of the vehicle interior is determined. In this process, a control unit can determine and/or receive a heating requirement and, depending on the determined heating requirement, control and operate the burner to generate heat energy.

According to a further embodiment, the at least one component is designed as an electric motor, power electronics, a control unit or as a traction battery, wherein the at least one burner is configured to burn a liquid, powdered, gaseous or solid fuel. This allows the burner to be used for thermal conditioning and/or heating of different components of the electric vehicle without consuming electrical energy from the electric vehicle traction battery.

### BRIEF DESCRIPTION OF THE FIGURES

The invention is schematically illustrated in the drawings with the aid of embodiments and is described further with reference to the drawings. In the figures:

FIG. 1 shows a schematic representation of an arrangement according to an exemplary embodiment of the invention.

FIG. 2 shows a schematic representation of a vehicle with an arrangement from FIG. 1.

FIG. 3 shows a schematic flowchart to illustrate a method according to an exemplary embodiment of the invention.

### DETAILED DESCRIPTION

Elements and components with the same or similar structural or functional features are provided with the same reference numerals throughout the figures.

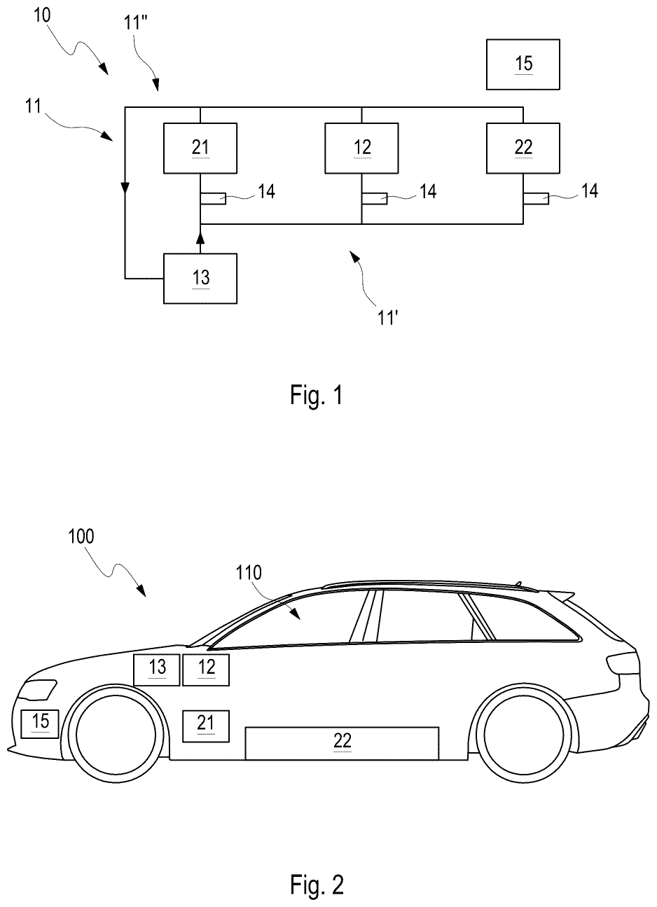

FIG. 1 shows a schematic representation of an arrangement 10 according to an exemplary embodiment of the invention. The arrangement 10 is designed to extend the range of an electric vehicle 100, which is shown by way of example in FIG. 2.

In particular, FIG. 1 shows a schematic representation to illustrate a possible setup of the arrangement 10. The arrangement 10 comprises a coolant circuit 11, at least one component 21, 22 of the electric vehicle 100 and at least one interior heat exchanger 12. Furthermore, the arrangement 10 in the exemplary embodiment shown includes a burner 13 which is thermally connected to the coolant circuit 11.

FIG. 2 shows a schematic representation of the vehicle 100 with the arrangement 10. The vehicle 100 is designed as an electric vehicle and has a traction battery 22 which can supply an electric motor 21 with electrical energy to drive the vehicle 100. Other components, such as gearboxes, actuators, circulation pumps and the like, are also normally included, but are not described or shown in detail for the sake of clarity.

The burner 13 is designed to generate heat energy and transfer it to the coolant circuit 11. For this purpose, the burner 13 can burn a fuel such as gas, gasoline, diesel and the like and convert chemical energy into thermal energy, which is then transferred to the coolant circuit 11 via a heat exchanger of the burner 13 (not shown). A coolant, such as water, an aqueous solution or oil, serves as a transfer medium for heat energy. The heat energy of the burner 13 is transferred to a warm side 11′ of the coolant circuit 11 and can be absorbed depending on the heating requirement of the respective components 12, 21, 22 connected to the coolant circuit 11.

The electrical components 21, 22 of the vehicle 100 are designed by way of example as an electric motor 21 and as a traction battery 22. Other components and parts, such as power electronics, control units, auxiliary units and drives, gearboxes and the like, are not shown for the sake of simplicity, but may also be thermally connected to the coolant circuit 11.

The exemplary electrical components 21, 22 and the interior heat exchanger 12 can be thermally coupled to the coolant circuit 11 via actuator units or valves 14. In particular, the valves 14 can control and/or regulate a volume flow of the coolant through a corresponding heat exchanger or heat transfer unit of the respective component 21, 22 or through the interior heat exchanger 12. The coolant can thus flow from the warm side 11′ of the coolant circuit 11 to a cold side 11′ of the coolant circuit 11 and be supplied back to the heat exchanger of the burner 13. For the sake of clarity, a circulation pump of the coolant circuit 11 is not shown.

In the illustrated exemplary embodiment, a control unit 15 of the arrangement 10 is configured to determine the heating requirement of the respective components 21, 22 and/or of a vehicle interior 110 (FIG. 2) and, based on the determined heating requirement, to activate the burner 13 or to regulate its output and/or to control the valves 14. By controlling the valves 14, the volume flow of the coolant passing through the respective valve 14 is changed.

In particular, the electrical components 21, 22 and/or the vehicle interior 110 can be heated before the vehicle 100 is operated and heated as required during all other operating modes in order to relieve the traction battery 22 and thus increase the electric range of the vehicle 100.

Arrangement 10, for example, enables the implementation of the following functions:
Thermal conditioning of the electrical components 21, 22 of the vehicle 100 before a vehicle start and/or during a journey
Maintaining a set operating temperature of the vehicle interior 110 and/or of the components 21, 22 in all operating states of the vehicle 100
Thermal conditioning of the traction battery 22 for fast charging
Heating the traction battery 22 during a charging process at low ambient temperatures
Implementing a parking heater function for heating the vehicle interior 110 during periods when the vehicle 100 is stationary with passengers in the vehicle interior 110, for example during an overnight stay in the vehicle 100 or during a waiting period.

The ability to control the heat energy fed into the coolant circuit 11 via the valves 14 allows individual heating circuits to be switched on and off, so that, for example, only the vehicle interior 110 can be heated by the burner 13. The amount of electrical energy required for this process is minimal, as only a circulation pump needs to be operated.

Depending on the shape and dimensions of the coolant circuit 11, circulation of the coolant can occur through convection, which allows the coolant to be circulated even without a circulation pump. This allows the vehicle 100 to be heated by the burner 13 even without consuming any electrical energy.

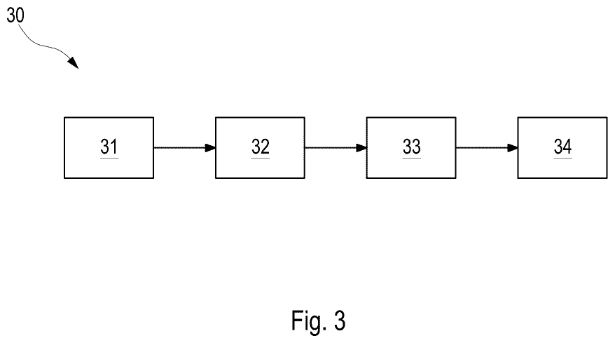

FIG. 3 shows a schematic flowchart to illustrate a method 30 according to an exemplary embodiment of the invention. The arrangement 10 and/or the vehicle 100 are configured in the illustrated embodiment to carry out the method 30.

Method 30 serves to extend the range of vehicle 100 and is described with reference to FIG. 1 and FIG. 2.

The heating requirement of at least one electrical component 21, 22 and/or of the vehicle interior 110 is determined in one step 31 of the method 30.

Subsequently, in a further step 32, at least one burner 13 of an arrangement 10 is activated and/or its output is regulated based on the determined heating requirement. This action can be carried out by control unit 15.

In a further step 33 of the method 30, heat energy generated by the burner 13 is fed into the coolant circuit 11. The heat energy fed into the coolant circuit 11 is then, controlled by at least one valve 14, supplied to at least one electrical component 21, 22 and/or to the interior heat exchanger 12 in a further step 34. This results in heat energy being absorbed or extracted from the coolant circuit 11.

The interior heat exchanger 12 can be used to heat the vehicle interior 110: For this purpose, a fan (not shown) can be provided or the vehicle interior 110 can be heated by natural convection of the air in the vehicle interior 110.

The at least one component 21, 22 and/or the interior heat exchanger 12 can be connected to the coolant circuit 11 via the at least one valve 14 to absorb heat energy provided by the burner 13. This allows heating requirements to be met without accessing the electrical energy of the traction battery, and extends or increases the electrically powered range of the vehicle.

### LIST OF REFERENCE NUMERALS

100 vehicle
110 vehicle interior
10 arrangement
11 coolant circuit
11′ warm side of the coolant circuit
11″ cold side of the coolant circuit
12 interior heat exchanger
13 burner
14 valve
15 control unit
21 component/electric motor
22 component/traction battery
30 method
31 determining heating requirements
32 controlling the burner and/or valves
33 feeding heat energy into the coolant circuit
34 extracting heat energy from the coolant circuit

1. An arrangement for extending the range of an electric vehicle, comprising: a coolant circuit, at least one component of the electric vehicle and at least one interior heat exchanger, and comprising at least one burner which is thermally connected to the coolant circuit and is configured to generate heat energy and supply it to the coolant circuit, wherein the at least one component and/or the interior heat exchanger can be thermally connected to the coolant circuit via at least one valve.

2. The arrangement according to claim 1, wherein the at least one component, which is designed as an electrical component of the electric vehicle, is configured to transfer heat energy in the form of power loss to the coolant circuit during operation of the electric vehicle and, before and/or during operation of the electric vehicle, to absorb heat energy provided by the burner for thermal conditioning.

3. The arrangement according to claim 1, wherein the interior heat exchanger can be connected to the coolant circuit by means of the at least one valve when there is a heating requirement for a vehicle interior of the electric vehicle.

4. The arrangement according to claim 3, wherein the at least one burner can be activated or controlled when a heating requirement or a change in a heating requirement of the at least one component and/or the vehicle interior is determined.

5. The arrangement according to claim 1, wherein the at least one component is designed as an electric motor, power electronics, a control unit, or a traction battery, wherein the at least one burner is designed to burn a liquid, powdered, gaseous, or solid fuel.

6. A vehicle which is designed as an electric vehicle, comprising an arrangement according to claim 1.

7. A method for extending the range of an electric vehicle, wherein a heating requirement is determined, a burner of an arrangement is activated and/or its power is controlled based on the determined heating requirement, wherein heat energy generated by the burner is fed into a coolant circuit, wherein the heat energy fed into the coolant circuit is controlled by at least one valve and supplied to at least one component and/or an interior heat exchanger.

8. The arrangement according to claim 2, wherein the interior heat exchanger can be connected to the coolant circuit by means of the at least one valve when there is a heating requirement for a vehicle interior of the electric vehicle.

9. The arrangement according to claim 2, wherein the at least one component is designed as an electric motor, power electronics, a control unit, or a traction battery, wherein the at least one burner is designed to burn a liquid, powdered, gaseous, or solid fuel.

10. The arrangement according to claim 3, wherein the at least one component is designed as an electric motor, power electronics, a control unit, or a traction battery, wherein the at least one burner is designed to burn a liquid, powdered, gaseous, or solid fuel.

11. The arrangement according to claim 4, wherein the at least one component is designed as an electric motor, power electronics, a control unit, or a traction battery, wherein the at least one burner is designed to burn a liquid, powdered, gaseous, or solid fuel.
